(19) United States
(12) Patent Application Publication
(10) Pub. No.: US 2024/0028750 A1
(43) Pub. Date: Jan. 25, 2024

(54) MANAGING SYSTEM, CONTROL METHOD FOR MANAGING SYSTEM, AND STORAGE MEDIUM

(71) Applicant: CANON KABUSHIKI KAISHA, Tokyo (JP)

(72) Inventor: TOSHIKI TSUBOI, Tokyo (JP)

(21) Appl. No.: 18/353,833

(22) Filed: Jul. 17, 2023

(30) Foreign Application Priority Data
Jul. 21, 2022 (JP) 2022-116659

(51) Int. Cl. G06F 21/60; G06V 20/56; G06V 20/52; G06V 40/10; G06T 7/00

(52) U.S. Cl. CPC G06F 21/602; G06V 20/56; G06V 20/52; G06V 40/10; G06T 7/0004

(57) ABSTRACT

A management system includes an edge device, and a blockchain network connected to the edge device. The edge device includes a processor, and a memory storing a program which, when executed by the processor, causes the edge device to execute recognition processing on acquired image data, hold attribute information related to capturing of the image data, and convert the image data into a hash value. The management system links, as linked data, the hash value converted by the edge device, the result of the recognition processing by the edge device, and the attribute information held by the edge device with one another, and registers the linked data in a distributed ledger in the blockchain network.

### BACKGROUND OF THE INVENTION

### Field of the Invention

The present invention relates to a managing system of an edge device in a blockchain network.

### Description of the Related Art

In recent years, data generation using deep learning techniques, such as a generative adversarial network (GAN), has become possible, and it is demanded to ensure the authenticity of data. WO 2020/079766 discloses a method for preventing the alteration of data in a distributed ledger identity verification system by recording acquired data in an edge device in a distributed ledger.

In the identity verification system according to WO 2020/079766, the identity verification is performed by extracting feature values of a target, and if it is determined that the identity is verified, the acquisition time and location are recorded in the distributed ledger, so as to prevent alteration.

However in the technique disclosed in WO 2020/079766, alteration of the acquired data itself cannot be prevented, and the authenticity of data, correct linking of feature values and acquired data, and the like may not be ensured.

### SUMMARY OF THE INVENTION

With the foregoing in view, it is an object of a technique of the present disclosure to ensure the recognition result using data in an edge device constituting a blockchain network and the authenticity of the data.

According to some embodiments, a management system including an edge device, and a blockchain network connected to the edge device, wherein the edge device includes a processor, and a memory storing a program which, when executed by the processor, causes the edge device to execute recognition processing on acquired image data, hold attribute information related to capturing of the image data, and convert the image data into a hash value, and the management system links, as linked data, the hash value converted by the edge device, the result of the recognition processing by the edge device, and the attribute information held by the edge device with one another, and registers the linked data in a distributed ledger in the blockchain network.

According to some embodiments, a control method for a management system of an edge device connected to a blockchain network, including a recognition step of causing the edge device to execute recognition processing on acquired image data, a holding step of causing the edge device to hold attribute information related to capturing of the image data, a conversion step of causing the edge device to convert the image data into a hash value, and a registration step of causing the management system to link, as linked data, the hash value converted in the conversion step, the result of the recognition processing in the recognition step, and the attribute information held in the holding step with one another, and register the linked data in a distributed ledger in the blockchain network. In addition, according to some embodiments, a non-transitory computer-readable storage medium which stores programs causing a computer to execute a control method for a management system of an edge device connected to a blockchain network, wherein the control method includes a recognition step of causing the edge device to execute recognition processing on acquired image data, a holding step of causing the edge device to hold attribute information related to capturing of the image data, a conversion step of causing the edge device to convert the image data into a hash value, and a registration step of causing the management system to link, as linked data, the hash value converted in the conversion step, the result of the recognition processing in the recognition step, and the attribute information held in the holding step with one another, and register the linked data in a distributed ledger in the blockchain network.

Further features of the present invention will become apparent from the following description of exemplary embodiments with reference to the attached drawings.

### BRIEF DESCRIPTION OF THE DRAWINGS

FIG. 1 is a diagram depicting a configuration of a management system according to Embodiment 1;

FIG. 2 is a diagram depicting a configuration of an edge device according to Embodiment 1;

FIG. 3 is a schematic diagram depicting an application example of the edge device according to Embodiment 1;

FIG. 4 is a diagram depicting a configuration of a blockchain according to Embodiment 1;

FIG. 5 is a diagram depicting a configuration of an edge device according to Embodiment 2;

FIG. 6 is a schematic diagram depicting an application example of the edge device according to Embodiment 2;

FIG. 7 is a diagram depicting a configuration of transaction data according to Embodiment 2;

FIG. 8 is a schematic diagram depicting an application example of an edge device according to Embodiment 3;

FIG. 9 is a diagram depicting a configuration of transaction data according to Embodiment 3;

FIG. 10 is a diagram depicting a management system according to Embodiment 4; and

FIG. 11 is a diagram depicting a configuration of a blockchain according to Embodiment 3.

### DESCRIPTION OF THE EMBODIMENTS

Embodiments of the present disclosure will be described with reference to the drawings. The present disclosure, however, is not limited to the following embodiments, and may be appropriately changed within a scope of not departing from the spirit thereof In the drawings to be described below, composing elements having a same function are denoted with a same reference sign, and description thereof may be omitted or simplified in some cases.

### Embodiment 1

A management system of each embodiment will be described with reference to the drawings. A management system according to Embodiment 1 is a management system that is configured assuming that a visual inspection is performed on a product (object) at a production plant. In Embodiment 1, means for acquiring image data on a product is a camera, for example, and an edge device performs determination processing to determine whether a product is non-defective/defective using image data on an image of the product captured by the camera.

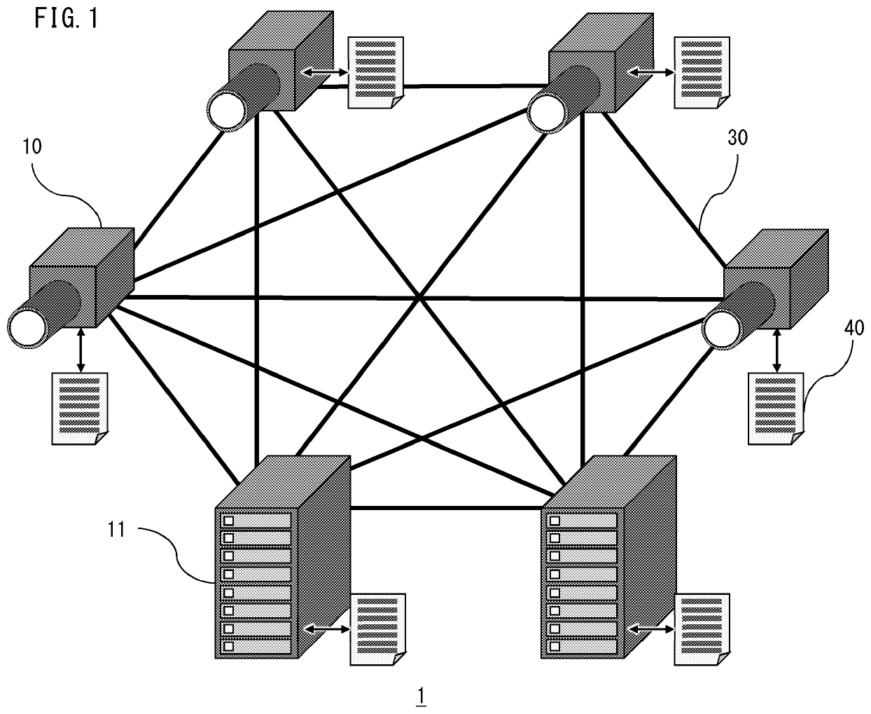

FIG. 1 is a block diagram depicting a configuration of a management system according to Embodiment 1. As illustrated in FIG. 1, in the management system 1, edge devices 10 and server devices 11 are connected by a blockchain network 30 via a wireless LAN and Ethernet cables. The edge devices 10 and the server devices 11 manage a blockchain 40 using a distributed ledger technique. As mentioned later, a hash value, a recognition result and an attribute information of image data acquired by an edge device 10 are held in the blockchain 40 as transaction data. Then each node, including the server device 11, manages the transaction data using the distribute ledge technique via the blockchain network 30. In FIG. 1, each edge device 10 constitutes a node of the blockchain network 30, but a device constituting a node of the blockchain network 30 is not limited to the edge device 10. For example, a device constituting a node may be the server device 11, or an information processing device having a communication function and a program execution function (e.g. desktop computer, notebook computer, smartphone).

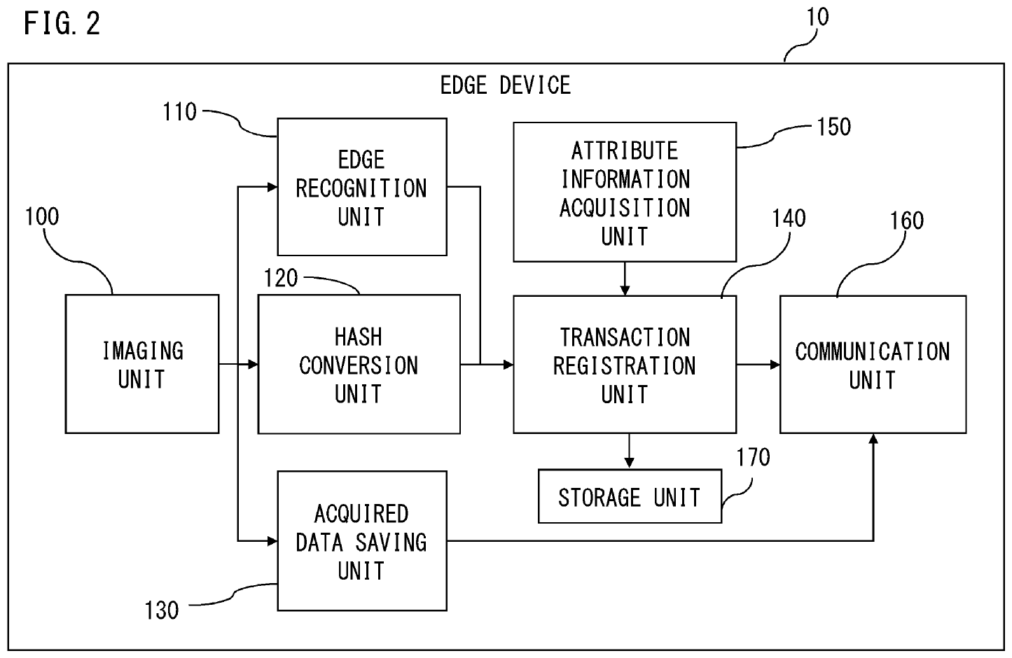

FIG. 2 is a block diagram depicting a general configuration of the edge device As indicated in FIG. 2, the edge device 10 includes an imaging unit 100, an edge recognition unit 110, a hash conversion unit 120, an acquired data saving unit 130, a transaction registration unit 140, an attribute information acquisition unit 150, a communication unit 160, and a storage unit 170. By the edge device 10 executing processing of each unit, a control method for the management system 1, to be described below, is implemented. Image data, which indicates an external view of a product captured by the imaging unit 100, is saved in the acquired data saving unit 130. For the acquired data saving unit 130, a storage device, such as a solid-state drive (SSD) and a hard disk drive (HDD), can be used. The storage unit 170 is holding means for holding attribute information relates to capturing of the image data. In a case where the edge device 10 does not have means for saving the acquired data, or in a case where the recording capacity of the acquired data saving unit 130 becomes full, the edge device 10 may send the acquired data to an external storage apparatus via the communication unit 160. The acquired data saving unit 130 and the storage unit 170 may be integrated into one storage means.

The image data acquired by the imaging unit 100 is converted into a hash value by the hash conversion unit 120, which is conversion means for converting the image data into a hash value. This conversion processing is processing to be executed to prevent alteration of the image data and to ensure the authenticity of the image data, using a characteristic of a hash function in which the hash value completely changes if data before the conversion is altered even slightly. For the hash conversion means to prevent alteration of the image data, MD5, SHA-1, SHA-224, SHA-256, SHA-384, SHA-512, SHA3-512, SHAKE128, SHAKE256, or the like is used, for example. The image data acquired by the imaging unit 100 is inputted to the edge recognition unit 110. The edge recognition unit 110 is recognition means for executing recognition processing on the inputted image data using an image recognition algorithm (e.g. machine vision) and artificial intelligence (AI). For the recognition processing, image processing techniques used for visual inspection, such as scoring a defect of a subject in the image data based on such a method as a convolutional neural network (CNN), and detecting a contamination position based on blob processing, can be used. The edge recognition unit 110 outputs the result of the recognition processing for the image data.

For the edge recognition unit 110, a graphic processing unit (GPU), a field programmable gate array (FPGA) or the like is used. In the edge device 10 of Embodiment 1, the imaging unit 100 is configured as the data acquisition unit, but a sensor to acquire data, such as a line sensor and temperature sensor, may be used as the data acquisition unit instead of the imaging unit 100.

The attribute information acquisition unit 150 acquires, for example, attribute information, including the acquisition date/time and acquisition steps, of the image data acquired by the imaging unit 100. Then the hash value of the image data converted by the hash conversion unit 120, the result of the recognition processing by the edge recognition unit 110 and the attribute information acquired by the attribute information acquisition unit 150, are outputted to the transaction registration unit 140. The transaction registration unit 140 links the hash value, the recognition processing result and the attribute information with each other, and register the linked data in the storage unit 170 as the transaction data on the blockchain network 30.

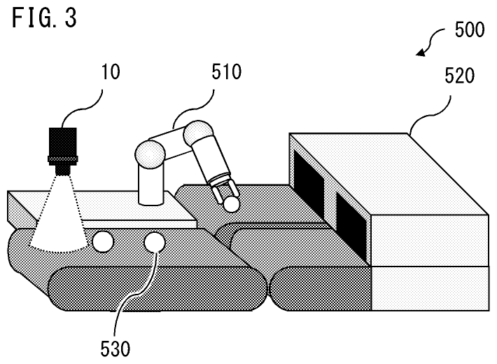

FIG. 3 is a schematic diagram depicting an application example of the edge device 10 according to Embodiment 1. In the case of the application example illustrated in FIG. 3, an external view of a work is inspected in a visual inspection line 500, using image data captured by the edge device 10. As illustrated in FIG. 3, the visual inspection line 500 is constituted of the edge device 10, a sorting device 510 and a conveying device 520. The edge device 10 executes the visual inspection processing on a work 530, which is a product manufactured at a production plant. On the basis of the result of the visual inspection by the edge device 10, the sorting device 510 separates the work 530 into a non-defective product or a defective product, and sends the work 530 to the conveying device 520.

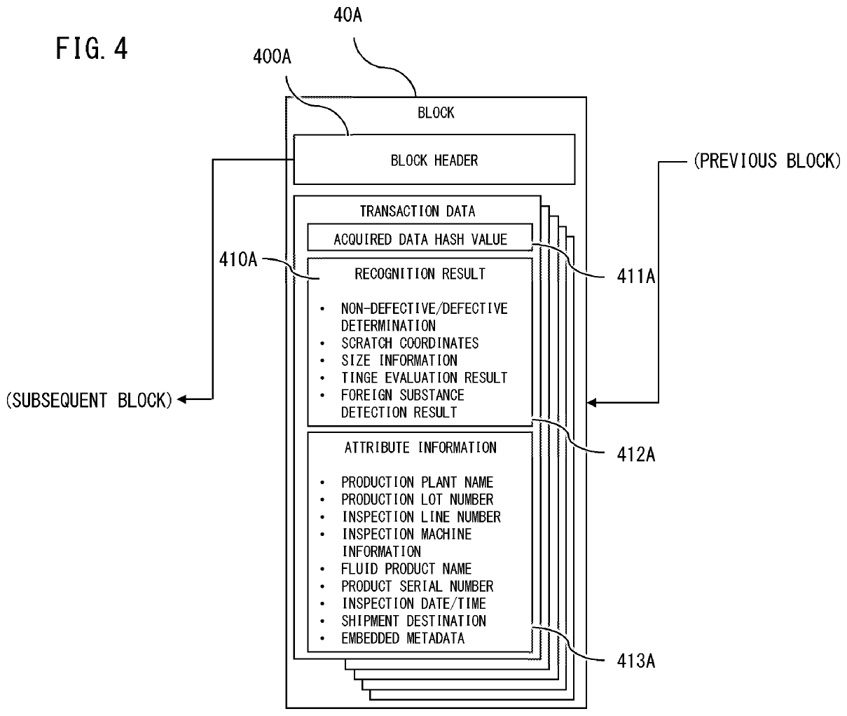

FIG. 4 indicates a configuration example of transaction data that is managed in the blockchain network 30 by the management system 1 according to Embodiment 1. As indicated in FIG. 4, a block 40A is connected with other blocks which are previous/subsequent in a time series, and constitutes a series of blockchains 40. The block header 400A includes a hash value of a previous block in the time series, and the hash value of the block 40A is included in the block header of the subsequent block in the time series. The block 40A includes the block header 400A and also transaction data 410A. As mentioned above, the transaction data 410A includes an acquired data hash value 411A, a recognition result 412A, and attribute information 413A.

Here the acquired data hash value 411A is a hash value of the image data acquired from the edge device 10. The recognition result 412A includes information to indicate the result of determining whether the work 530 in the image data acquired by the edge device 10 is non-defective or defective. Furthermore, the recognition result 412A includes: information on foreign substance detection result which indicates the presence/absence of a scratch, a foreign substance, or the like, information on coordinates and the seriousness of the scratch, foreign substance, or the like on the work if any; information to indicate the size of the work 530; and digitized information on sensory evaluation (e.g. tinge).

The attribute information 413A is, for example, information acquired from the edge device 10, and is process information including: a management number and production plant name of the visual inspection line 500; a product name and serial number of the work 530, a production lot number; and a shipment destination of the conveying device 520. The process information also includes the information on the inspection machine, inspection date/time, shipment destination of product, and the like. The attribute information 413A is information on capturing of images acquired by the edge device 10, and includes information on various apparatuses used for capturing images, and information on the environment in which images are captured.

The hash value 411A, the recognition result 412A and the attribute information 413A of the series of data acquired by the edge device 10 are combined and registered in the block 40A as the transaction data 410A. Thereby a blockchain of the transaction data is configured.

It is a characteristic of a blockchain that alteration of a block influences subsequent blockchains, hence alteration of a block is difficult. Therefore the traceability of the hash value, the recognition result, and the attribute information of the image data on the work 530 acquired by the edge device 10 is ensured. In Embodiment 1, the acquired data itself is not managed, but the hash value is managed in the block 40A, so as to conserve block capacity. Therefore, the traceability of the image data, the recognition result, and the attribute information is ensured by matching the information included in the block 40A and the information included in the image data which the acquired data saving unit 130 stored separately. To match the information, the inspection data/time information and the like included in the attribute information 413 A can be used. In this case, if unique metadata is embedded in a head portion or the like of the image data, as indicated in FIG. 4, the information included in the metadata can be included in the attribute information 413A, and is managed thereby.

As described above, according to the management system 1 of Embodiment 1, the traceability and authenticity of the image data in the visual inspection of the work are ensured, whereby the evidential capability of information on problems related to the shipment of defective products can be enhanced.

### Embodiment 2

A management system according to Embodiment 2 will be described next. In the following description, a composing element the same as Embodiment 1 is denoted with a same reference sign, and detailed description thereof will be omitted. The management system according to Embodiment 2 is a management system assuming an autonomous driving system of automobiles. In Embodiment 2, it is assumed that a distance sensor of a camera, an LiDAR, a radar sensor, or the like is used as means for acquiring data, for example, and recognition processing is performed on the acquired data by the edge device 10, and the recognition result is used for autonomous driving.

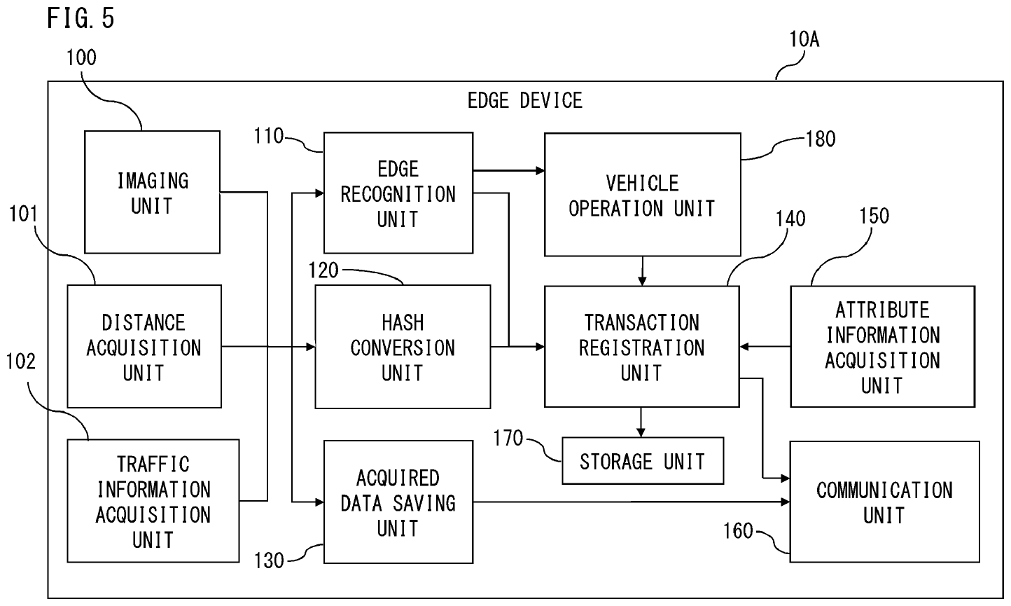

FIG. 5 indicates a configuration example of an edge device 10A of a management system 1 according to Embodiment 2. Just like the edge device 10 of Embodiment 1, the edge device 10A mounted on a vehicle which performs autonomous driving includes the imaging unit 100, but a difference from the edge device 10 of Embodiment 1 is including a distance acquisition unit 101, a traffic information acquisition unit 102 and a vehicle operation unit 180. For the distance acquisition unit 101, a stereo camera, an LiDAR sensor, a radar sensor or the like is used, and for the traffic information acquisition unit 102, communication means, which is configured to be communicable with traffic lights, is used. The edge device 10A performs recognition processing while the vehicle is travelling, on the basis of the information acquired by a plurality of information acquisition means, including the distance acquisition unit 101 and the traffic information acquisition unit 102, and performs the so called “sensor fusion operation”. In Embodiment 2, data acquired by the plurality of sensors is used for the recognition processing by the edge recognition unit 110, and based on this recognition result, the vehicle operation unit 180 operates an autonomous driving vehicle in which the edge device 10 is mounted.

The transaction registration unit 140 links the recognition result by the edge recognition unit 110, vehicle operation result including steering and acceleration/deceleration performed by the vehicle operation unit 180, hash values of the acquired data by the sensors, and attribute information acquired by the attribute information acquisition unit 150. Then the transaction registration unit 140 registers the linked data in the storage unit 170 of the edge device 10 as the transaction data on the blockchain network 30.

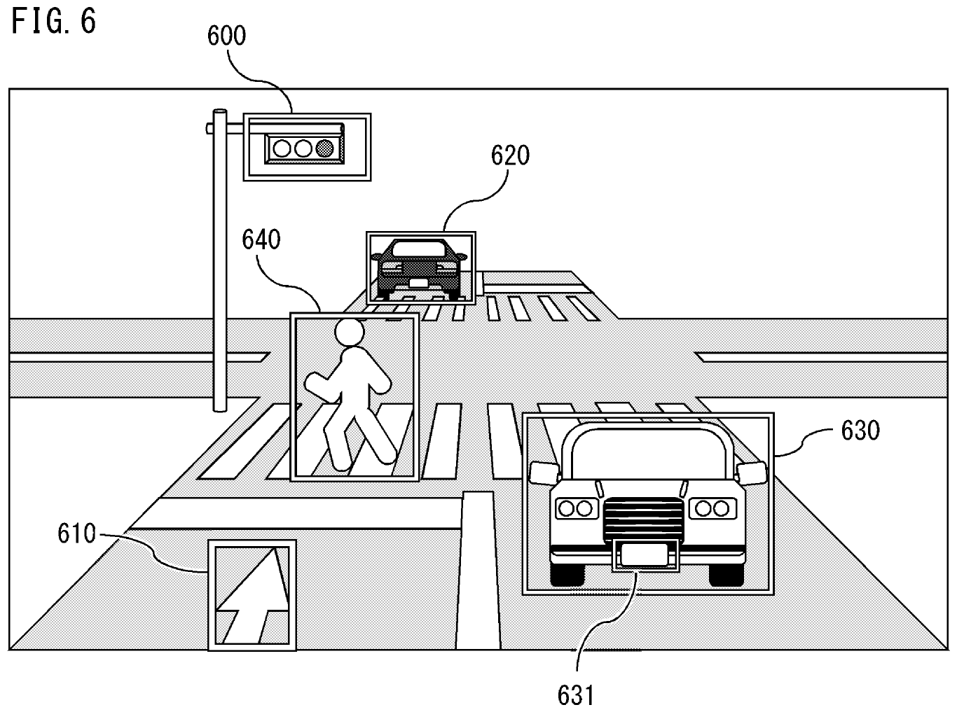

FIG. 6 schematically indicates an example of recognition result when the edge device 10A performed the recognition processing based on the acquired image data according to Embodiment 2. The edge recognition unit 110 executes the recognition processing using information acquired by the imaging unit 100, the distance acquisition unit 101, and the traffic information acquisition unit 102 respectively. As illustrated in FIG. 6, in the image captured by the imaging unit 100, a traffic light 600, a traffic sign 610, a vehicle head 620, another vehicle 630, a pedestrian 640, and the like are recognized in the recognition processing by the edge recognition unit 110. On the basis of this recognition result, the vehicle operation unit 180 performs autonomous driving of the vehicle in which the edge device 10A is mounted.

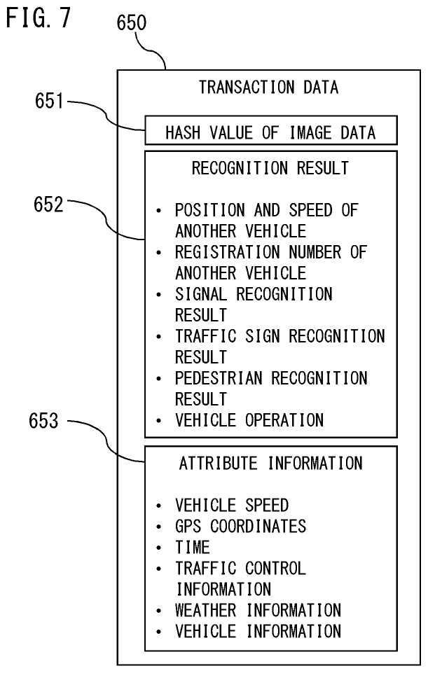

As indicated in FIG. 7, the transaction registration unit 140 of the edge device registers the recognition result by the edge recognition unit 110 and the vehicle operation result in the storage unit 170 as a recognition result 652 of transaction data 650 on the blockchain network 30. The recognition result 652 includes: a position, speed and registration number of another vehicle 630, a signal recognition result which indicates a signal state of the traffic light 600, a traffic sign recognition result which indicates the content of the traffic sign 610, a recognition result of a pedestrian 640, and vehicle operation which indicates the content of the autonomous driving by the vehicle operation unit 180.

The transaction registration unit 140 stores information acquired by the edge device 10A, such as speed information of the vehicle, GPS coordinates, time, traffic control information, weather information and the vehicle information, in the storage unit 170 as the attribute information 653 of the transaction data 650. The recognition result 652 and the attribute information 653 registered in this way, along with the hash value 651 of the image data acquired by the imaging unit 100, are registered in a block as the transaction data 650.

Just like Embodiment 1, the block registered in the edge device 10A forms a series of blockchains as mentioned above. Thereby the traceability and authenticity of the transaction data, including the image data and the recognition result acquired by the edge device, are ensured. According to the management system 1 of Embodiment 2, the traceability and authenticity of the image data and recognition result, which are critical for autonomous driving of a vehicle, are ensured, hence the evidential capacity of information in an accident caused by the autonomous driving vehicle can be enhanced.

### Embodiment 3

A management system according to Embodiment 3 will be described next. In the following description, a composing element the same as Embodiments 1 and 2 is denoted with the same reference sign, and detailed description thereof will be omitted. The management system according to Embodiment 3 is a management system constructed assuming a monitoring camera system and an access management system. In the management system 1 of Embodiment 3, a plurality of edge devices constituting the blockchain network 30 perform the recognition processing in cooperation, whereby the recognition accuracy of the data recognition processing can be enhanced.

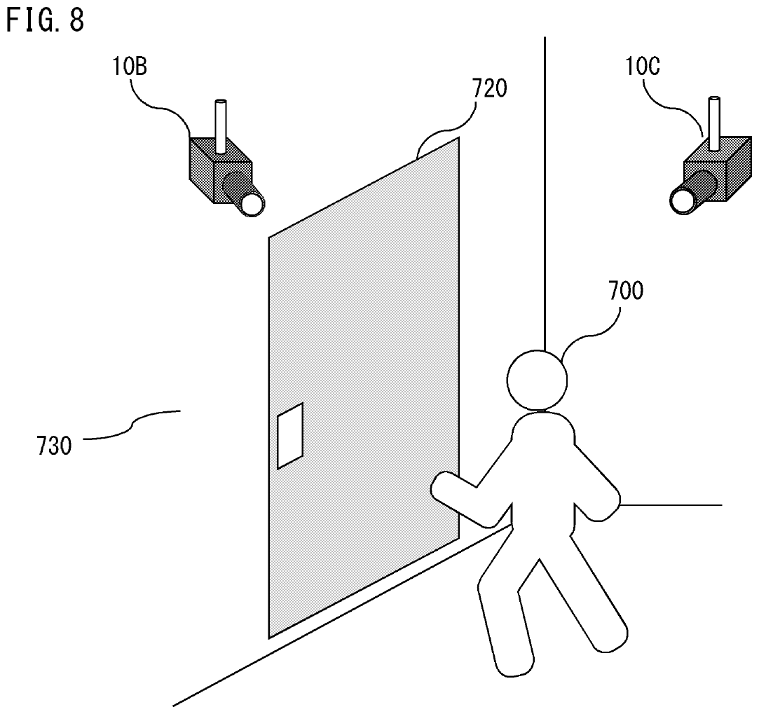

FIG. 8 indicates an application example of edge devices 10B and 10C constituting the blockchain network 30 in the management system 1 according to Embodiment 3. In the example illustrated in FIG. 8, the edge devices 10B and 10C are installed near a door 720 of a room 730, and captures images of a person 700 near the door 720. The edge devices 10B and 10C execute recognition processing on image data acquired by the image capturing, and determine whether the person 700 is a suspicious person or an employee, for example, based on the recognition result. In some cases, recognition accuracy in the recognition processing of the image data may be different between the edge device 10B and the edge device 10C, due to the angles of view when the edge devices 10B and 10C capture images, the orientation of the person 700, and the like. In this case, the edge devices 10B and 10C may calculate the scores of the respective recognition results and a recognition result having a higher score may be used.

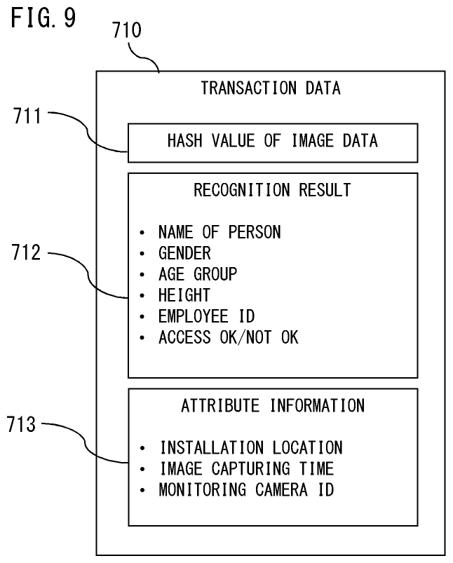

As indicated in the example in FIG. 9, in the edge devices 10B and 10C, the transaction registration unit 140 registers the recognition result by the edge recognition unit 110 in the storage unit 170 as a recognition result 712 of the transaction data 50 on the blockchain network 30. The recognition result 712 includes: a name, gender, age group, height, employee ID, access to the room 730 OK/not OK, and the like of an imaged person 700 of which image was captured. The information to identify the person 700, such as the name and employee ID of the person, may be stored in the storage unit 170 in advance.

The transaction registration unit 140 registers the installation information that can be acquired by the edge devices 10B and 10C, such as installation location of each edge device, image capturing time, and ID to uniquely identify the monitoring camera, in the storage unit 170 as the attribute information 713 of the transaction data 710. The recognition result 712 and the attribute information 713 registered in this way are registered, along with a hash value 711 of the image data acquired by the imaging unit 100, as the transaction data 710.

Therefore according to Embodiment 3, accuracy of the personal recognition result and access records of the monitoring cameras performed by the edge devices 10B and 10C and evidential capacity thereof can be enhanced.

### Embodiment 4

A management system according to Embodiment 4 will be described next. In the following description, a composing element the same as Embodiments 1 to 3 is denoted with the same reference sign, and detailed description thereof will be omitted. The management system according to Embodiment 4 is a management system constructed assuming a case of using the edge drive as a digital camera for general consumers. Specifically, in a management system 200 according to Embodiment 4, the edge device 10 forms a public blockchain network 31. A difference from the management system 1 of Embodiment 1 is that the management system 200 performs Proof of Work (PoW) or Proof of Stake (PoS). The edge device 10 may include a microphone device and use a moving image capturing function, just like a standard digital camera, and in the following description, it is assumed that a moving image is captured by the edge device 10.

In this description, it is assumed that the edge device 10 is a digital camera that can capture moving image data, but the edge device 10 may be a smartphone, a tablet, or the like. The data acquired by the edge device 10 is not limited to the moving image data, and the edge device 10 may be Internet of Things (IoT) sensor or a microphone having a configuration different from the imaging unit of the edge device 10.

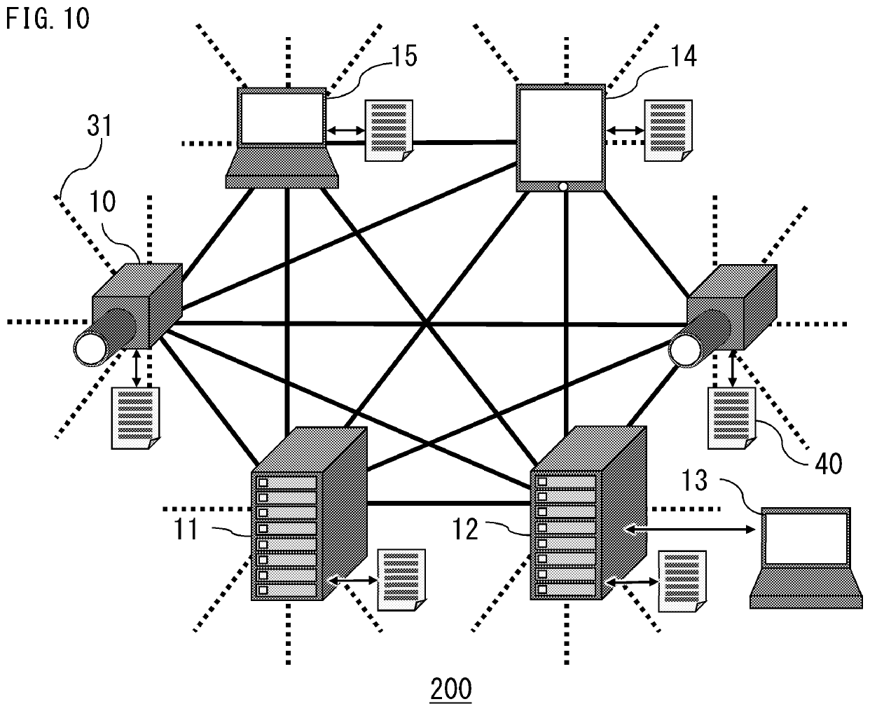

FIG. 10 indicates a configuration example of the management system 200 according to Embodiment 4. As illustrated in FIG. 10, the edge device 10 is connected to the public blockchain network 31. The edge device 10, along with the server device 11, the cloud server device 12, the tablet terminal 14, the laptop terminal 15, and the like, manages the blockchain 40 using the distributed ledger technique. Here the client terminal 13 remotely connects the cloud server device 12 using such a protocol as Secure Shell (SSH).

The edge device 10 links a hash value of moving image data based on the captured moving image, the recognition result and the attribute information, and registers the linked data in the storage unit 170 of the edge device 10 as transaction data on the public blockchain network 31. In Embodiment 4, the public blockchain network 31 is used as the blockchain network. Therefore, the edge device 10 ensures the authenticity of the moving image data by executing processing using such a consensus algorithm as Proof of Work (PoW) and Proof of Stake (PoS). It is also possible that the edge device 10 itself performs mining as a node device, and ensure the authenticity of the moving image data thereby.

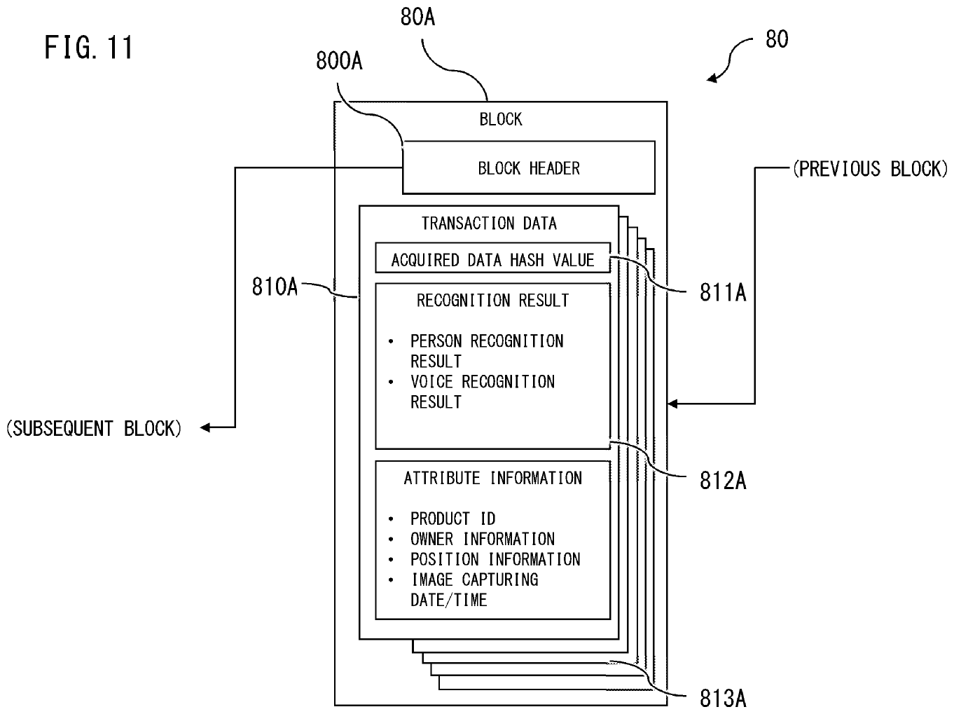

FIG. 11 indicates an example of a block according to Embodiment 4. As indicated in FIG. 11, a block 80A is connected with other blocks which are previous and subsequent blocks in the time series, and constitutes a series of blockchains 80. A block header 800A includes a hash value of the previous block in the time series, and the hash value of the block 80A is included in the block header of the subsequent block in the time series. The block 80A includes transaction data 810A along with the block header 800A.

The hash value of the moving image data of the moving image captured by a digital camera, which is the edge device 10, is included in the transaction data 810A as an acquired data hash value 811A. Specifically, the hash conversion unit 120 converts image data and audio data included in a moving image in a predetermined period, such as predetermined seconds or minutes, out of the captured moving image, into a hash value, and the converted hash value becomes the acquired data hash value 811A. A person recognition result and an audio recognition result, which are the result of the recognition processing which the edge device 10 executed using the moving image data, are included in the transaction data 810A as a recognition result 812A. Furthermore, a product ID and owner information of the digital camera, which is the edge device 10, and attribute information of the camera, such as location information to indicate the moving image capturing location, and the moving image capturing date and time, are also included in the transaction data 810A as camera information 813A.

For example, in an interview of a celebrity, a hash value of a moving image data of a moving image captured by the edge device 10, a person recognition result, audio recognition result, location information and image capturing data and time when the moving image was captured, owner information of the camera, and the like, are managed by the public blockchain network 31. Thereby the authenticity of the moving image data is ensured, and ownership of the moving image data can be verified. Further, the edge device 10 may link the transaction data and the moving image data of the captured moving image, whereby a non-fungible token (NFT) is issued, and ownership of the moving image data can be verified.

Therefore according to the management system 200 of Embodiment 4, authenticity of the moving image data of the moving image captured by the digital camera, which is the edge device 10, is ensured, and ownership thereof is verified, whereby the digital copyright of the moving image data can be protected.

Whereas the management system of the present disclosure has been described in detail based on the preferred embodiments thereof, the present disclosure is not limited to these specific embodiments, and various other modes within a scope not departing from the technical spirit of the present disclosure are also included in the present disclosure. The plurality of embodiments described above may be combined when necessary.

For example, in the above embodiments, the edge device is configured as a node of the blockchain network, but an electronic apparatus, to store the transaction data, may be used as the node of the blockchain network instead of the edge device. In this case, in the above embodiments, the edge device need not include the storage unit, and may be configured as an external electronic apparatus of the blockchain network. In other words, in the above embodiments, the camera may be configured as a node of the blockchain network, or as an external electronic apparatus of the blockchain network. Furthermore, in the above embodiment, a target to be converted into a hash value included in the transaction data may be image data acquired by the edge device or may be moving image data.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, the authenticity of data acquired by an edge device connected to a blockchain network can be ensured.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-116659, filed on Jul. 21, 2022, which is hereby incorporated by reference herein in its entirety.

What is claimed is:

1. A management system comprising:
an edge device; and
a blockchain network connected to the edge device, wherein
the edge device includes
a processor; and
a memory storing a program which, when executed by the processor, causes the edge device to
execute recognition processing on acquired image data,
hold attribute information related to capturing of the image data, and
convert the image data into a hash value, and
the management system links, as linked data, the hash value converted by the edge device, the result of the recognition processing by the edge device, and the attribute information held by the edge device with one another, and registers the linked data in a distributed ledger in the blockchain network.

2. The management system according to claim 1, wherein
the recognition processing is processing to inspect an external view of an object, and
the attribute information includes process information of the inspection.

3. The management system according to claim 1, wherein
the recognition processing is processing to recognize an object while a vehicle is travelling, and
the attribute information includes vehicle information related to a travelling of the vehicle.

4. The management system according to claim 1, wherein
the recognition processing is processing to recognize a person of which image is captured by a monitoring camera, and
the attribute information includes installation information of the monitoring camera.

5. The management system according to claim 4, wherein
the recognition processing is processing to recognize the person entering or exiting a room.

6. The management system according to claim 1, wherein
the image data is image data captured by a digital camera, and
the attribute information includes owner information of the digital camera.

7. The management system according to claim 1, wherein
the program which, when executed by the processor, further causes the edge device to:
acquire audio data related to the image data;
execute recognition processing on the audio data;
hold attribute information related to the audio data;
convert the image data and the audio data into a hash values, and
the management system links, as the linked data, the hash values of the image data and the audio data, the result of the recognition processing of the image data, the result of the recognition processing of the audio data, the attribute information related to the image data, and the attribute information related to the audio data with one another, and registers the linked data in the distributed ledger.

8. The management system according to claim 1, wherein the blockchain network is a public blockchain network.

9. The management system according to claim 8, wherein
the program which, when executed by the processor, further causes the edge device to execute mining for the information registered in the distributed ledger.

10. The management system according to claim 8, wherein
the program which, when executed by the processor, further causes the edge device to issue a non-fungible token (NFT) related to the image data.

11. A control method for a management system of an edge device connected to a blockchain network, comprising:
a recognition step of causing the edge device to execute recognition processing on acquired image data;
a holding step of causing the edge device to hold attribute information related to capturing of the image data;
a conversion step of causing the edge device to convert the image data into a hash value; and
a registration step of causing the management system to link, as linked data, the hash value converted in the conversion step, the result of the recognition processing in the recognition step, and the attribute information held in the holding step with one another, and register the linked data in a distributed ledger in the blockchain network.

12. A non-transitory computer-readable storage medium which stores programs causing a computer to execute a control method for a management system of an edge device connected to a blockchain network, wherein
the control method includes:
a recognition step of causing the edge device to execute recognition processing on acquired image data;
a holding step of causing the edge device to hold attribute information related to capturing of the image data;
a conversion step of causing the edge device to convert the image data into a hash value; and
a registration step of causing the management system to link, as linked data, the hash value converted in the conversion step, the result of the recognition processing in the recognition step, and the attribute information held in the holding step with one another, and register the linked data in a distributed ledger in the blockchain network.
